(19) United States
(12) Patent Application Publication
(10) Pub. No.: US 2005/0120206 A1
(43) Pub. Date: Jun. 2, 2005

(54) Method and system for rule-based certificate validation

(76) Inventors: John Hines, San Mateo, CA (US); Piyush Jain, Milpitas, CA (US); Stefan Kotes, Cupertino, CA (US)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 10/726,751

(22) Filed: Dec. 2, 2003

(51) Int. Cl. H04L 9/00

(52) U.S. Cl. 713/158

(57) ABSTRACT

A rule-based cryptographic services module is provided by way of a CAPI interface so as to provide security services over a plurality of protocols. The rule-based module applies logical rules to processing results provides from the plurality of protocols to identify an appropriate processing method for each request for security services received by the module. Accordingly, a greater degree of efficiency and speed are provided when processing cryptographic services requests over the CAPI interface.

### FIELD OF THE INVENTION

The present invention relates to computer security, and more particularly to determining the status of certificates.

### BACKGROUND OF THE INVENTION

A Public Key Infrastructure (“PKI”) environment is one in which a plurality of communicating nodes employ certificates containing encryption keys and identification information to ensure that communication between nodes is secure. Examples of such keys are security keys used to operate high security computer systems, which are associated with at least one certificate. An example standard certificate is the X.509 protocol certificate. These certificates are issued and revoked by registration organizations generally referred to as Certificate Authorities (“CAs”).

In the MICROSOFT windows platform, software vendors are provided with the ability to call system functions provided by the operating system CryptoAPI interface. Some of the available functions include CertVerifyRevocation( ), and CertGetCertificateChain( ). The calling application is thus able to determine certificate status without having to comply with the various algorithms or protocols associated with the various revocation methods. The operating system automatically attempts to provide the requested certificate-related operation by employing registered revocation provider (“RP”) services. CAPI allows for registering multiple RPs which the operating system attempts to employ in a sequential manner. For example, if the status of a certificate cannot be determined from the first default RP, the next RP is called in an attempt to resolve the application request. Hence, the interaction between the various RPs is still managed by the default operating system algorithm without communication or other interaction between the various RPs employing different processing protocols. This can lead to wasted operations and reduced response time. Accordingly, there is a need for an integration of the various services and protocols provided by the plurality of RPs.

### SUMMARY OF THE INVENTION

The present invention takes advantage of the CAPI function calls by providing a rule based certificate Validator application (“Validator”) which facilitates the various functions and protocols previously provided by the plurality of RPs. The Validator receives a certificate service request from an application that requested a CAPI function. The Validator determines the certificate type for the associated certificate. The Validator then retrieves a processing algorithm by reference to processing rules applicable to the identified certificate type. The processing includes fail-over conditions which specify the interaction between the various validation methods available to the Validator.

In one embodiment, the present invention provides for a method for facilitating rule-based processing of CAPI function requests by interposing a rule-based application as a primary revocation provider of the CAPI interface and associating certificate types with processing rules in the interposed rule-based application. The method facilitates certificate processing requests by employing one of a plurality of protocols as specified by said processing rules. The method also examines a processing result by reference to a rule-based algorithm. The method determines whether a condition of the rule-based algorithm is applicable to the processing result. If a condition is applicable to the processing result, the method applies an action corresponding to the condition. The action may includes specifying a second protocol for implementing the certificate processing request. Finally, the method provides certificate processing results from the rule-based application to the CAPI interface.

### BRIEF DESCRIPTION OF THE DRAWINGS

FIG. 1 illustrates logical software components associated with revocation services provision in accordance with the invention;

FIG. 2 is a flow diagram illustrating the operation of a Validator of the invention; and

FIG. 3 is a flow diagram illustrating processing of revocation responses by a Validator of the invention.

### DETAILED DESCRIPTION OF THE INVENTION

The structure and operation of a certificate services architecture of the invention will now be discuss by reference to figures illustrating an exemplary system. First, the structure of the system is discussed by reference to logical components associated with operating system certificate services. Next, the operation of a Validator module of the exemplary system is discussed by reference to a flow diagram. Finally, operation of the rule-based Validator when employing a plurality of protocols is illustrated by reference to a flow diagram.

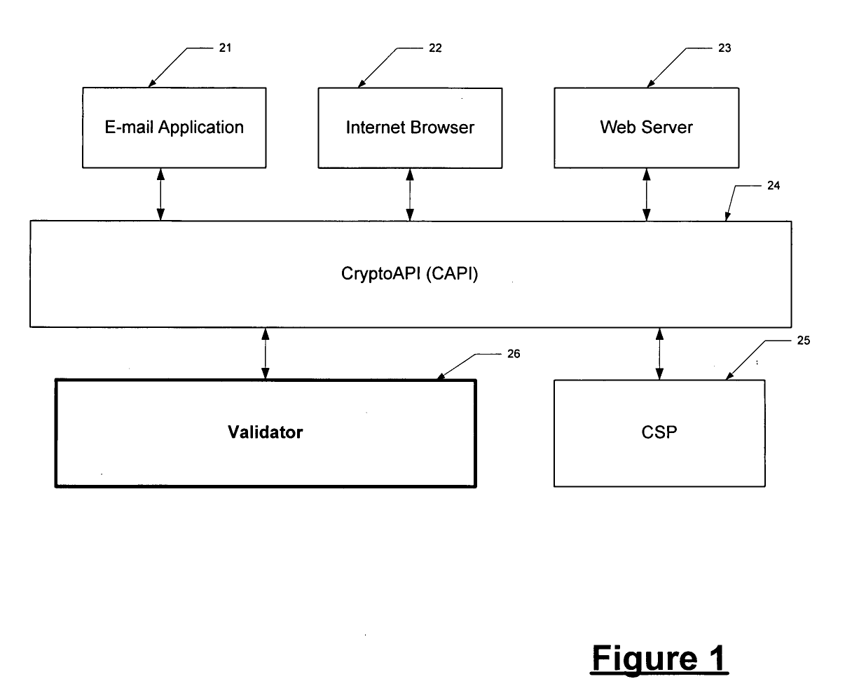

FIG. 1 illustrated logical software modules associated with certificate services in an example system. The logical components include an email application 21, an internet browser 22, a web server 23, a CryptoAPI interface 24, a Certificate Services Provider (CSP) 25, and the Validator module 26. The e-mail application 21, internet browser 22, and web server 23, include encryption and authentication features, as is known in the art. When facilitating these encryption and authentication features, the applications employ the CAPI services provided by the operating system. The CAPI interface 24 provides functions, which facilitate encryption services. Some of the provided functions include those that provide a revocation status for a certificate, register a certificate, and retrieve certificate chain from a certificate. The CSP 25 provides CryptoAPI functions and services to applications such as Internet Explorer, Outlook, Outlook Express, Internet Information Server (IIS), and Internet Security and Acceleration Server (ISA). The Validator 26 is provided as the only RP in the system so as to service all function call from the CAPI interface 24.

The Validator 26 provides customizable rule-based management of certificate processing in accordance with user preferences as specified by a user interface. In some embodiments, the Validator 26 provides certificate revocation services by reference to a local database of revocation data. The operation and updating of such local database is discussed in co-pending application number *, which is incorporated by reference herein.

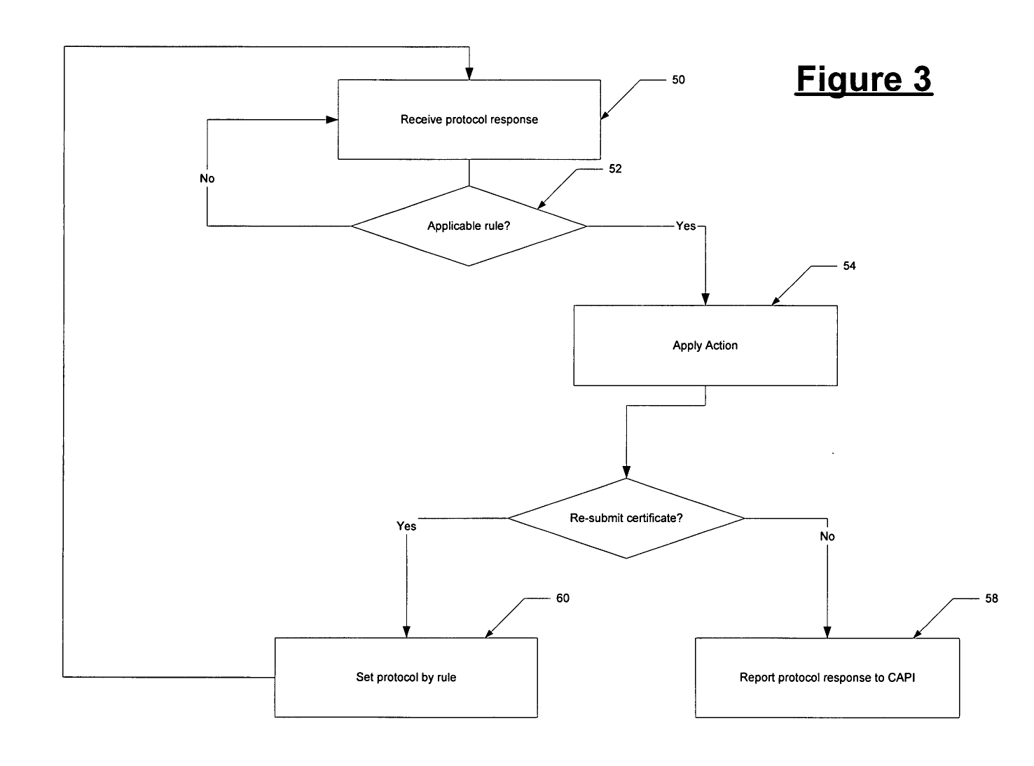

In one embodiment, the Validator user interface is provided by a Windows based application which is adapted to facilitate the submission of conditions and corresponding actions. As is known in the art, several configurations and interfaces available for facilitating submission of conditions and rules are suitable for use with the Validator module of the invention. The operation of the Validator 26 in evaluating conditions and executing actions is discussed in further detail below with reference to FIG. 3.

The revocation providers facilitate the execution of certificate services as applicable to the called CAPI functions. As in known, such services include OCSP, SCVP, CRL. The Validator 26 is also adapted to provide revocation services previously unavailable by standard RPs, such as by supporting exclusive certificate validation based on certificate CRLdp extension. In other embodiments, the Validator 26 further implements processing rules which are adapted to employ validation information specified in a previously validated certificate.

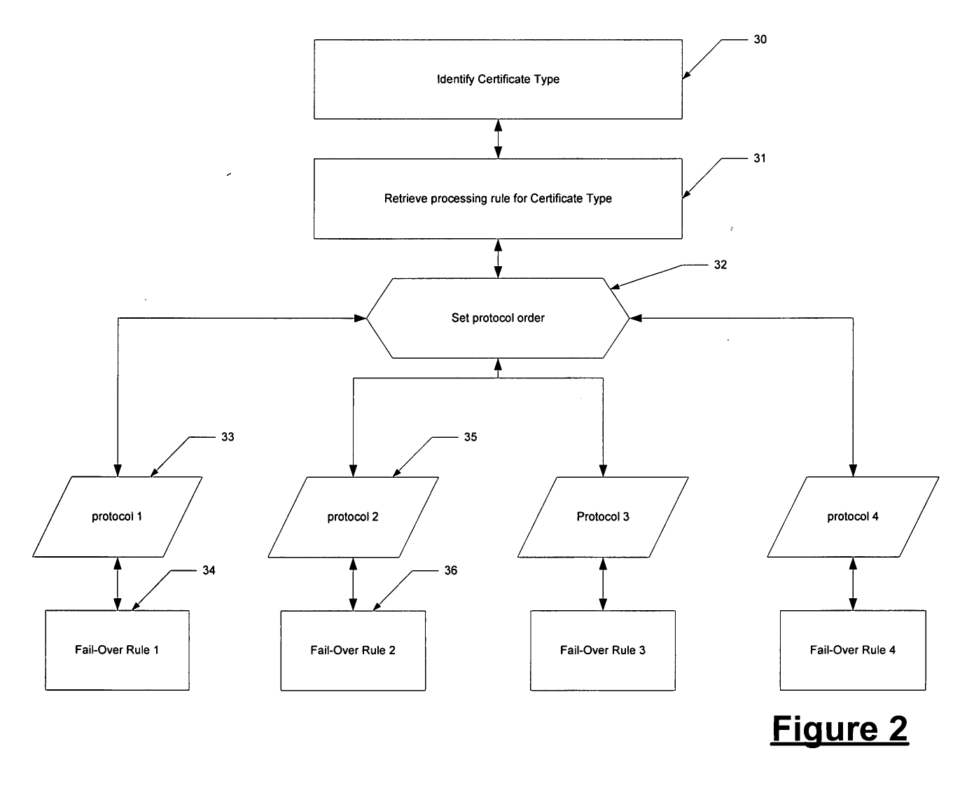

FIG. 2 is a flow diagram illustrating the general operation of the Validator 26 when processing a function request from the CAPI interface. The Validator first identifies the certificate type (Step 30). The processing rules for the certificate type are then retrieved from a rule database by reference to the identified certificate type (Step 31). The protocol order is set by reference to the retrieved processing rules (Step 32). A first protocol is used to facilitate the desired function (Step 33). Based on the results of the processing by the first protocol, a first fail-over rule is applied (Step 34). The rule may require processing by employing a second protocol (Step 35), which is also associated with a fail-over rule (Step 36). The fail-over rule preferably specifies logic that is used to determine a follow-up processing in case of a failed operation.

FIG. 3 illustrates the operation of the Validator when considering the applicability of rules and corresponding actions to revocation provider responses. The Validator receives a response from a revocation provider after submitting a request by employing a first protocol (Step 50). The Validator determines whether a rule is applicable to the response received from the protocol request submission by reviewing relevant conditions (Step 52). If there is no applicable rule, the Validator submits the operation request by employing the same protocol. If there is an applicable rule, the Validator applies the action which corresponds to the rule (Step 54). If the corresponding action requires re-submitting the operation request, the Validator sets the revocation provider to the protocol provided by the resubmit action and submits the operation request (Step 60). If the corresponding action does not require re-submitting the operation request, the Validator provides the protocol response to the CAPI interface as a return value (Step 58). In other embodiments, the Validator employs two protocols simultaneously to service a request, as may be applicable to the service request.

As is appreciated, the present invention significantly improves the performance of application requesting certificate services by customizing the processing of certificates by reference to the certificate extension type such as AIA extension or CRLdp extension. Hence when a certificate service is requested, the Validator selects rules based on information in certificate extension or in validation configuration database. Hence substantial operative advantages are provided by the rule-based Validator in both terms of response time and reliability.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A method for facilitating rule-based processing of CAPI function requests, comprising:
interposing a rule-based application as a primary revocation provider of the CAPI interface;
associating certificate types with processing rules in the interposed rule-based application;
facilitating certificate processing requests by employing one of a plurality of protocols as specified by said processing rules;
examining a processing result by reference to a rule-based algorithm;
determining whether a condition of the rule-based algorithm is applicable to the processing result;
applying an action corresponding to the condition if a condition is applicable to the processing result, the action includes specifying a second protocol for implementing said certificate processing request; and
providing certificate processing results from the rule-based application to the CAPI interface.
